(19) United States
(12) Patent Application Publication
(10) Pub. No.: US 2023/0088343 A1
(43) Pub. Date: Mar. 23, 2023

(54) ENCAPSULATING TRAVEL GUITAR AND SIMILAR STRINGED INSTRUMENTS

(71) Applicant: Karl Scott Purdy, San Antonio, TX (US)

(72) Inventor: Karl Scott Purdy, San Antonio, TX (US)

(21) Appl. No.: 17/478,909

(22) Filed: Sep. 18, 2021

(51) Int. Cl. G10D 3/095; G10D 1/08; G10D 3/04

(52) U.S. Cl. CPC G10D 3/095; G10D 1/08; G10D 3/04; G10D 3/14

(57) ABSTRACT

A guitar is a stringed instrument including a body with a removable lid, bridge/saddle ensemble, two-piece neck, and head (with string channels) so all parts can fit into the instrument's body. The body and lower half of the neck are assembled (and disassembled) using a tongue-and-groove system. The neck pieces are adjoined with repeatable precision using 3 steel rod and tube assemblies. The head slides on and off the end of the neck using two rods/pins and a neck conforming head-to-neck stabilization receptacle. The removable bridge/saddle combination uses a pivot, bridge stabilizer, and pin system to hold it flush to the body, and when pinned down, holds all other pieces in place via the instrument's string tension.

### CROSS-REFERENCE TO RELATED APPLICATIONS

US PATENT DOCUMENTS

| | | |
|---|---|---|
| 3,910,151 | October 1975 | Copeland . . . |
| 4,573,391 | March 1986 | White . . . |
| 5,058,479 | October 1991 | Shaw . . . |
| 5,353,672 | November 1994 | Stewart . . . |
| 6,025,548 | February 2000 | Ehrlich . . . |
| 6,028,255 | February 2000 | Myronyk . . . |
| 7,375,267 | May 2008 | Poschelk . . . |
| 7,705,224 | April 2010 | Ward . . . |
| 9,424,818 | August 2016 | Spangler . . . |
| 9,454,947 | September 2016 | Hart . . . |

Foreign Patent Documents

| | | |
|---|---|---|
| WO 2014167272 | October 2014 | Brain . . . |
| WO 17061254 | April 2017 | Niiro . . . |
| DE102007026655 | March 1980 | Brunner . . . |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Travel is nearly essential for professional musicians, but amateurs and hobbyists enjoy playing wherever they go as well. A common problem for stringed instrument musicians, particularly for guitarists (or larger stringed instruments) is the relatively bulky, awkward nature of the instrument and difficulty transporting it. Carrying cases exacerbate the challenge by adding weight and additional bulk, and the instruments almost always have to be left in the care of baggage handlers. Musicians who transport their instruments in soft, lower priced, protective bags to avoid the inconvenience and added cost of baggage handling, take on the risk of passengers shoving hard-case luggage onto or around the guitar in the designated storage bins. This is particularly true on airplanes, busses, and trains, but even transporting in one's own vehicle can be somewhat daunting to ensure the instrument does not incur damage. It is desirable to avoid extreme temperatures, for instance, thus requiring the instrument to be carried in the passenger compartment rather than non-environmentally controlled compartments. Ideally, it is carriable in a bag just large enough for a laptop computer, medium sized purse, or small back pack, and easily stored within the owner's arm's reach or under the seat in front of the owner.

The awkward nature of the guitar is mostly due to the neck. It contributes to more than 50% of the overall length of most acoustic versions of the instrument and well over 60% for most solid body models. The neck is traditionally permanently affixed to the hollow bodied instrument or requires tools and extreme care not to damage or “strip” the screw or bolt threads when removing it from solid body instruments. This is quite inconvenient and time consuming each time the guitar is transported as it also requires loosening (also known as detuning) and removing the strings. Upon reassembling the guitar, the same care and time is required to reattach the neck, the strings (restringing), and then retune the strings. With repetition, strings tend to break prematurely.

Finally, the sound the instrument produces is essential, if not a significant element for any musician and their audience. A collapsible instrument's sound, when assembled, should resemble a conventional instrument as much as possible. There are two elements of sound quality that are hampered when an instrument's integrity is altered; duration and timbre. Duration (also known as sustain), measured in time, is how long or short the sound is sustained from the perception of onset to conclusion. A musician may, for instance, strike a single string with the intention its duration lasts while playing a series of other notes using other strings. An instrument's sound duration (that is, unhampered by the musician) is typically impacted when vibration absorbing material is added to the instrument, thus decreasing the longevity of the sound. Timbre is the quality of the sound or tone created when striking the strings. A string should emit a clear or “bright” tone when struck over the sound hole of a guitar. If the musician desires for the tone to have a dull sound, there are techniques he or she can use to create it. If the instrument's natural tendency is a dull tone, however, the musician cannot apply techniques to create a bright tone without electronic manipulation such as an effects device built into an amplifier. Timbre is also impacted by the addition of extraneous material, but also by size and shape of the instrument's body, or by shortening the neck, and thus the distance between the frets used for creating notes. As the neck is shortened, the strings require less tension to create the same notes, changing the tone of the sound. An extreme example would be the sound of a ukulele compared to that of a guitar. Combined, duration and timbre contribute to the instrument's resonance which is the quality of a sound that stays loud and clear for a long time.

The key for a collapsible stringed instrument, then, is to reduce it to a convenient, manageable size; disassemble and reassemble without tools, and without detuning and restringing; and when assembled maximizing its resonance when played.

Folding neck instruments have been attempted, whereby the neck and instrument's body are adjoined by a hinge and perhaps augmented by an additional locking mechanism; and while reducing the overall length of the instrument when in the folded position, the neck adds bulk (or depth) to the overall collapsed size. Further, the neck is still relatively long by itself and the folded guitar's length is still such that it requires storage and transport in storage bins or compartments and thus still susceptible to damage. A folding neck introduces another concern when considering the fragility of a single hinge small enough to accommodate a relatively narrow and long neck. The integrity of the hinge and its connection to the neck and body becomes exposed to twisting and other vulnerabilities while in the folded position. Another disadvantage of the hinge is its inherent physics to absorb vibration rather than propagate it, thus impeding a natural sustained duration of a note played by the musician. Collapsible guitars must have snugly fitting parts to repel vibration in order not to compromise sound quality.

Other variations of collapsible and travel guitars have been created to reduce the size for transportation, such as removable necks, but have yet to address the relatively long length of the neck and how to reduce it without sacrificing the sound created by a full-sized instrument. Indeed, the neck is the most critical guitar element due to the precision of distance between the frets along the fingerboard (supported by the neck) required to create the notes. Thus, neck alteration is typically avoided when creating a collapsible stringed instrument.

It is evident, then, a discerning traveling musician desires a collapsible stringed instrument transportable without damage risk or inconvenience, easily disassembled without tools and detuning, reassembled without tools and restringing, and able to replicate a full-sized instrument's sound when assembled. More specifically, a need exists for a full-size instrument comprising multiple, detachable, snug-fitting parts, small enough to be encapsulated and stored within the instrument's body, transportable in a small bag, and when reassembled, has the same look, feel, and sound as an unaltered full-scale instrument.

### BRIEF SUMMARY OF THE INVENTION

The present invention teaches a collapsible kit assembly for musical string instruments having a body, neck, and head. The invention incorporates multiple detachable pieces including a two-piece neck, a body, stabilization rods, a bridge/saddle ensemble, and a head. When all pieces are assembled, it resembles a full-size instrument in look, feel, play, and sound. When disassembled, all parts fit inside the instrument's body which fits in a laptop computer-sized bag. The art depicts an acoustic (hollow) body guitar with a removable lid, two separate neck pieces, three steel rods, the head, and a quick release detachable bridge. The concept is repeatable for a solid body guitar, but the pieces are stored in separate compartments in the same small bag.

The invention is embodied by a stringed instrument including a body, a bridge/saddle ensemble, a two-piece neck, and a head, all of which are detachable from their normal interfaces. All detachable pieces are without threaded hardware requiring manipulation such as a screw, bolt, knob, or wing nut. There are no hinges or levers. Each piece fits properly with its respective interface using complementary matching geometrical configurations.

The two-piece neck consists of a lower neck and upper neck. The lower neck is defined as that which interfaces with the body and the upper neck. The upper neck is defined as that which interfaces with the lower neck and the head. The head is defined as the part by which the tuning mechanisms, hereafter referred to as tuners, are attached. The tuners are where the strings terminate and are tightened or loosened to achieve a desired musical note. The bridge/saddle ensemble attaches to the body of the instrument and is the part by which the strings originate.

The interface between the body and the lower neck is via a tongue and groove geometry. In one embodiment, the tongue is located on the neck with a matching groove receptacle on the body allowing the lower neck to align in a typical convention. In another embodiment, the tongue and groove are swapped such that the groove is cut into the neck and the tongue is included in the body's receptacle for the neck.

The upper neck fits to the lower neck by means of two (or more) steel rods, and an equivalent number of paired steel (or other alloy or composite material) tubes inside the neck pieces. That is, for each pair of tubes, there is a steel rod. The paired tubes are embedded in both the upper and lower neck pieces, respectively, and each pairing is parallel to the other one (or more) pairing(s). Each tube in the lower neck is paired and precisely aligned with a tube in the upper neck such that a single steel rod, when the lower neck and upper neck are assembled, is fully encased equally in each lower neck and upper neck tube pairing. Three such pairings are used in this embodiment, but as few as two, to as many as can be fit into a typical neck, may reap similar capability.

The head fits to the upper neck in a similar fashion except the head has two partially embedded steel rods whose ends are protruding from within a receptacle (for upper neck) at the base of the head, that insert into two parallel steel tubes embedded in the upper neck. The receptacle provides the necessary stability resisting twist, as well as housing the string channels which guide the strings efficiently and rapidly over the nut during assembly.

A bridge/saddle ensemble attaches to the bridge support plate which in turn can be easily attached to the instrument body via a pivot slot on the body lid (e.g. guitar's front face) and pinned to the guitar base. The bridge support plate can compose of composite, plastic, wood, or alloy material durable and strong enough to withstand the forces placed upon it by the strings' tension while supporting the bridge and saddle. The bridge support plate rests flatly on the lid and secured in place by the strings' tension pulling the bridge support firmly into the pivot slot when secured. In another embodiment, the lid of the instrument can have a shallow cutout up to the same depth and of equal size and shape of the bridge support plate thus eliminating the need for tabs. Said cutout allows for the strings, in the instrument's assembled condition, to be closer to the frets and/or fingerboard. The distance between the strings and fingerboard is defined as the “action”. For a solid body guitar, a cutout to decrease the action may be preferred. In another embodiment, tabs attached to the bridge support and slide into slots cut into the body lid. The bridge support can be pivoted similarly and pressed firmly against the body lid and held down with a hinged flap or solid L-shaped device (bridge stabilizer) that folds over a hole where an avibank pin can be installed through the bridge stabilizer and into the instrument's body.

In any of the above embodiments, all parts and pieces fit inside the cavity of the acoustic instrument body, which can be carried in a laptop size computer bag or small backpack. For the solid body embodiment, the parts are easily stored within the same size bag because the solid body is slimmer compared to the hollow cavity of the acoustic instrument.

### BRIEF DESCRIPTION OF THE SEVERAL VIEWS OF THE DRAWING

The present invention's embodiments are hereinafter discussed with reference to the drawing figures, described as follows.

FIG. 1 is an exploded perspective view of a collapsible guitar, illustrating the major components minus the guitar strings.

FIG. 2 depicts the Body 1 at the end where the Lower Neck 2 slides into position atop the Neck Deck 10. The Body-Lower Neck Receptacle 9 includes grooves accommo-dating the tongue on either side of the Lower Neck 2.

FIG. 3 is an isometric view of the Lower Neck 2 from the end that slides into the Body 1. The aforementioned tongue 13 is clearly depicted to provide the viewer a logical perspective on how the Lower Neck fits snuggly into the Body 1. A rendering of the fretboard 11 and the 8^{th} fret 12 are shown as foreshadowing to where the Lower Neck and Upper Neck conjoin.

FIG. 4 is a front view of the Lower Neck Interface Plate 15 which matches the Upper Neck plate. The three Lower Neck Stabilization Holes 14 are where the steel rods are inserted into the Lower Neck 2.

FIG. 5 depicts the front view of the Upper Neck Interface Plate 16 and its matching set of stabilization holes 17 for insertion of steel rods into the upper neck 4. The nut 18 and 7^{th} fret 19 are also depicted in this view.

FIG. 6 provides an isometric view of the Upper Neck 4 from the Upper Neck Interface Plate 16 end. At the opposite end of the Upper Neck, the viewer can clearly see an extension of the Upper Neck 4 well beyond the nut 18. The extension is defined as the Upper Neck-Head Stabilizer Insert 20 which slides into the Head-Neck Stabilization Receptacle (shown in FIG. 8) FIG. 7 shows an exploded cross section view of the entire neck depicting the Lower and Upper Neck Stabilization Holes 14 and 17, (or tubes) that encase the Steel Neck Alignment and Stabilization Rods 3, and the Upper Neck-Head Alignment Holes 22.

FIG. 8 shows a front view of the Upper Neck-Head Stabilizer Insert 20 with detail of the Upper Neck-Head Alignment Holes 22.

FIG. 9 is detailed art depicting an end view of the Head 5 including the Head Alignment Pins 24 and Head-Neck Stabilization Receptacle 26, the Head-Neck Interface Surface 28 where the Upper Neck Stabilization Insert comes to rest in the assembled position, and the Head-Nut Interface Surface 29 where the nut 18 comes to rest in the assembled position. Also depicted are the String Alignment Channels 25. The String Tunnels And Tuner Isolation Cap (STATIC) is intentionally not shown in this figure to better display the Tuning Pins 27.

FIG. 10 is an exploded side view of the Upper Neck 4 and the Head 5. The purpose of the figure is to give an additional perspective of how the two pieces conjoin and the angle of the head supporting the tuners.

FIG. 11 is a cross section view of the “upper portion” of the Upper Neck 4 depicting the Upper Neck-Head Alignment Holes 22, and a front view of the Head 5 including the Head Alignment Pins 24, the SAC 25, and the Tuning Pins 27. The nut is not depicted in this art to simplify the view.

FIG. 12 is an isometric view of the Bridge Support Plate 7 giving a better perspective of the curved pivot and the aft Conforming Ridge 32 that rests on the Body 1 when in the secured position. It also depicts the Bridge/Saddle 34 and Bridge Support Pivot 33. The Tailpiece String Holes 35 are where the strings originate when stringing the instrument. The Holes for Securing the Bridge to the Bridge Support Plate 42 are depicted as Countersunk Holes. In other embodiments, these can be of any variety.

FIG. 13 is an isometric top (outside) view of the Guitar Lid 6 which depicts a typical sound hole 39, a Conforming Ridge 38 for holding the lid in place on the body, and the curved “half pipe” Bridge Support Pivot Receptacle 36 for the Bridge Support Pivot 33. In another embodiment, the lid can be the back side of the instrument, but likely requires an additional clamping device to secure it to the instrument when in place.

FIG. 14 shows the bottom (inside) face of the Guitar Lid 6 that offers more detail of the Conforming Ridge 38, the Guidepost Tabs 30, and the Bridge Support Receptacle 37.

FIG. 15 displays how all the pieces fit in an orderly fashion within the instrument body.

### DETAILED DESCRIPTION OF THE INVENTION

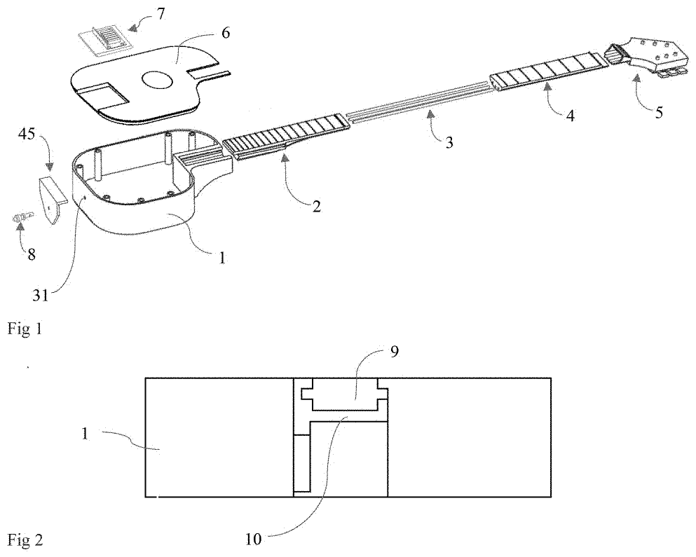

Exemplary embodiments of musical stringed instruments having a body, neck, and head constructed in accordance with the present invention are described in detail with reference to the accompanying art. For simplicity of description, a guitar is used as an example of the stringed instrument thereupon this invention can be used. Further, a stringed instrument according to the present invention may be an acoustic guitar wherein the sound of the guitar is projected acoustically, or alternatively, may be a solid body (more commonly known as “electric”) guitar wherein the sound of the guitar is projected through electronic amplification. By way of example, and not by limitation, the exemplary embodiment of the instrument shown and described herein is an acoustic guitar. An acoustic guitar, indicated generally by the totality of the exploded perspective in FIG. 1, comprises a body, indicated by reference character 1 and its lid, indicated by reference character 6, a detachable lower neck, indicated by reference character 2, alignment and support rods indicated by reference character 3; a detachable upper neck indicated by reference character 4; a detachable head indicated by reference character 5; a bridge/saddle ensemble indicated by reference character 7; and a Bridge Securing Pin indicated by reference character 8. The aforementioned pieces, with the exception of the Body 1 and Body Lid 6 fit into the body's cavity for compact, convenient storage and or transportation. The Body Lid 6 is detached and reattached to the Body 1 to enclose the body's cavity. Further, all pieces are secured in their respective assembled positions by the tension of the strings with a single exception. The Bridge Support Plate 7 is held in place with Bridge Support Pivot 33 lodged in the Bridge Support Pivot Receptacle 36 and fastened down into the Bride Support Receptacle 36 with the Bridge Support Stabilizer 45 secured by a Bridge Securing Pin 8 inserted in the Bridge Securing Pin Receptacle. Further, all pieces can be fabricated with any suitable material or materials such as natural or synthetic wood, composites, plastic or other material with characteristics complying with the builder's desired quality and end use.

FIG. 2 is an end view perspective of an acoustic guitar Body 1 depicting the Body-Lower Neck Receptacle 9 and the Neck Deck 10 upon which the Lower Neck 2 slides into place. The geometrically matched tongue on the Lower Neck 2 fits snugly into the Body-Lower Neck Receptacle 9 and against the Neck Deck 10. The snug fit created by the rigidity of the tongue and groove connection within the Body-Lower Neck Receptacle 9, the Neck Deck 10, and the Lower Neck 2 significantly contributes to the duration (a.k.a sustain) of the strings' vibration, a desirable quality.

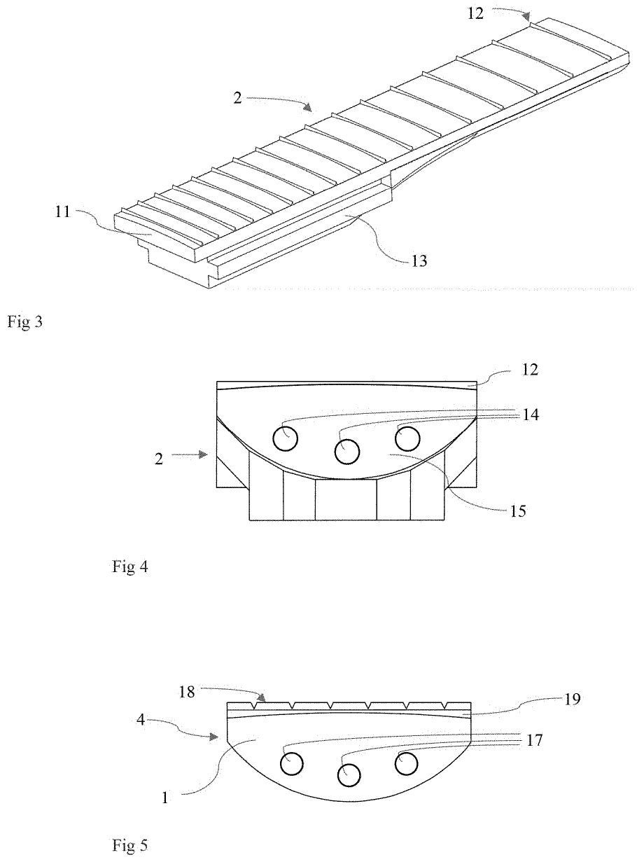

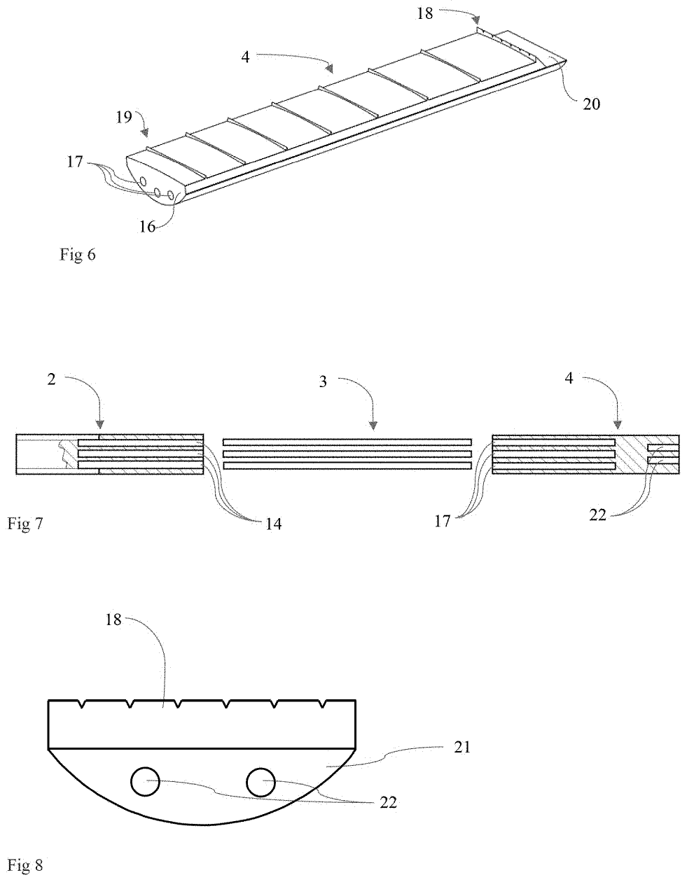

FIG. 3 is an isometric view showing the detachable Lower Neck 2. The Tongues 13 on either side of the Lower Neck 2 share the same dimensions as its mated grooves in the Body-Lower Neck Receptacle 9. The Fingerboard 11 extends a relatively short distance beyond the Lower Neck's 2 trunk, which when assembled, overlaps the guitar Body Lid 6 by an equivalent distance. This helps secure the Body Lid 6 in place. The depiction of the Eighth Fret 12 on the Fingerboard 11, shown in FIG. 3, combined with the view of the Ninth Fret 19, shown in FIG. 6, demonstrates the Lower-Upper Neck Interface 15 in FIG. 4, and Upper-Lower Neck Interface 16, depicted in FIG. 5 and FIG. 6, occurs half the distance between the frets. In other embodiments, the adjoining of the Lower Neck 2 and the Upper Neck 4 can occur between any of the frets, or for fretless fingerboards, somewhere in the proximity of the center of the neck. The key is to ensure neither the Lower Neck 2 nor Upper Neck 4 is such a length as being unable to fit inside the guitar Body 1 cavity or in the carry bag or case for the guitar.

FIG. 4 and FIG. 5 highlight the matching symmetry of the holes 14 and 17, for the Lower Neck 2 and Upper Neck 4, respectively, that encase the Steel Neck Alignment and Support Rods 3 when assembled. The holes 14 and 17 are an essential element for a two-piece neck, and must be precisely drilled so be parallel with the neck and one another. In another embodiment, precisely manufactured tubes allowing free but snug insertion of the Steel Neck Alignment and Support Rods 3 are utilized to ensure neck stability in the assembled state. The same is true for the Upper Neck-Head Alignment Holes 22 shown in FIG. 8. All holes are clearly depicted in an exploded cross-section view of the neck in FIG. 7.

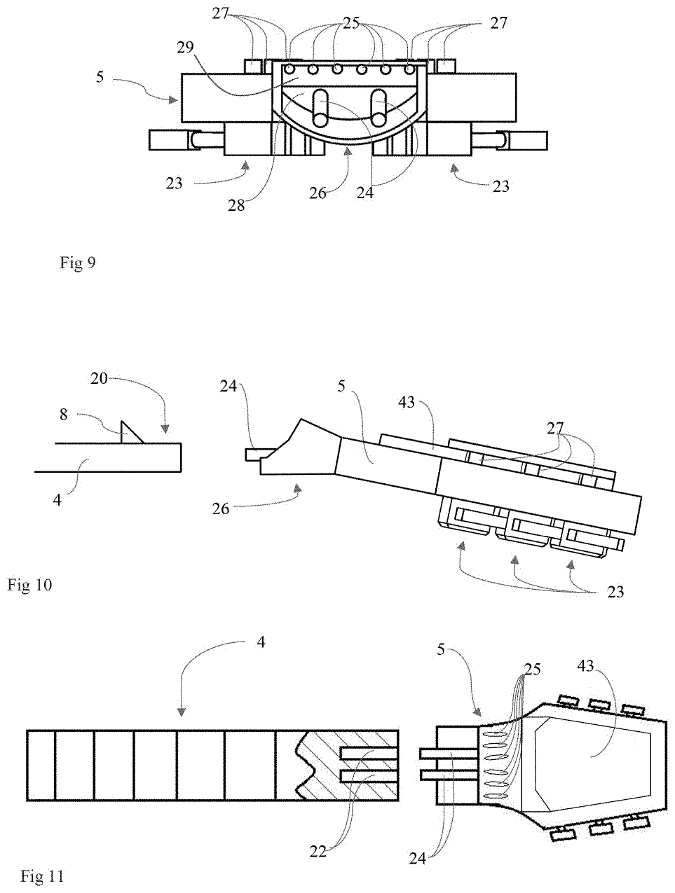

The Head 5 supports the Tuners 23 (and Tuning Pins 27 which are part of the Tuners), shown in FIGS. 9 through 11, in a conventional manner common for stringed instruments. The present art adds a unique, rigid Head-Neck Stabilization Receptacle 26, shown in FIG. 9 and FIG. 10, eliminating twist when the Upper Neck 4 and Head 5 are conjoined and the strings under tension. This feature provides the same rigidity, and thus resonance qualities, as if the neck and head were a single piece of material. The Head Alignment Pins 24 shown in FIGS. 9 through 11 slide into the Upper Neck-Head Alignment Holes 22, shown in FIG. 8 and FIG. 11, until the Upper Neck-Head Interface 21 on the Upper Neck-Head Stabilizer Insert 20, shown in FIG. 6 and FIG. 10, is flush with the Head-Neck Interface Surface 28. The purpose of the Upper Neck-Head Stabilizer Insert 20 is to provide the Head-Neck Stabilization Receptacle 26 a portion of the Upper Neck 4 to wrap around without interfering with the strings while providing the musician the same unaltered, smooth neck feel when playing chords and notes in proximity of the Nut 18. As best shown by the detail in the bottom view of the Head 5 in FIG. 9, the geometry of the Head-Neck Stabilization Receptacle 26 cavity is the same as the Upper Neck-Head Stabilizer Insert 20 providing for a snug fit when assembled and contributing to the instrument's resonance. Further, the Head-Nut Interface Surface 29, which is part of the Head-Neck Stabilization Receptacle 26, mates with the head side of the Nut 18 when assembled. The String Alignment Channels 25 are small diameter holes that pass through the Head-Nut Interface Surface 29 as shown in FIG. 9 and FIG. 11. The String Alignment Channels 25 each line up with their respective notch in the Nut 18 such that the strings conveniently and quickly fit into their respective notches when the Upper Neck 4 and Head 5 are assembled. The space between the String Alignment Channels 25 and the STATIC 43 allows space for a Capo 42 to further contribute to preventing strings from unraveling when disassembling and storing the Head 5.

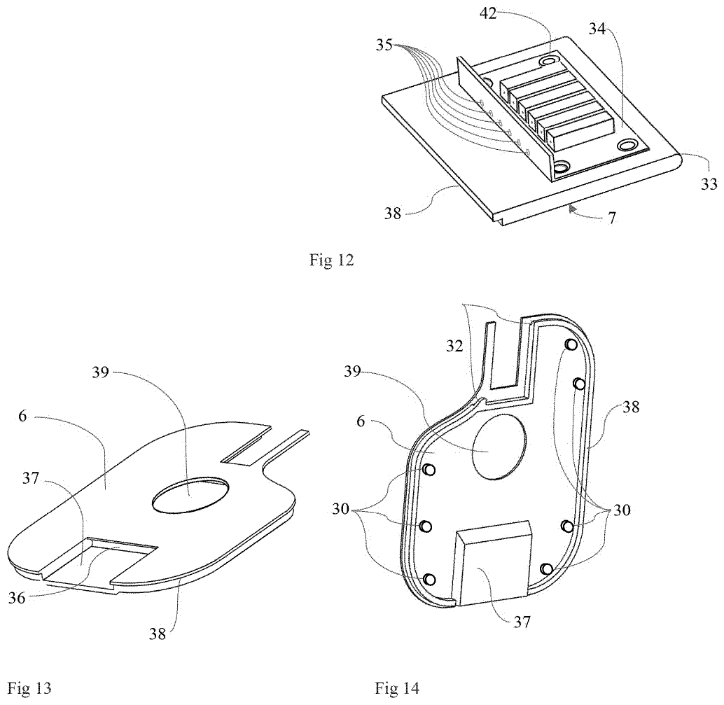

The Bridge/Saddle Ensemble 34, from which the strings originate when stringing the instrument, is shown in FIG. 12. The Bridge/Saddle Ensemble 34 is secured to the Bridge Support Plate 7 with countersunk screws or bolts suggested by the Holes for Securing Bridge to Bridge Support Plate 42 in FIG. 12. Countersunk holes minimize any chance of hardware interfering with string vibration. In other embodiments, the bridge can be secured with adhesives, rivets, or similar. The Bridge Support Plate 7 features including the Bridge Support Pivot 33, the Conforming Body Ridge 38 which rests on the guitar body when locked into position, and the Bridge which shows the Tailpiece Guitar String Holes 35 are shown in FIG. 1 and in detail in FIG. 12.

FIG. 13 is an isometric view of the instrument's Body Lid 6. The Body Lid 6 has a Bridge Plate Pivot Receptable 36 that allows the conforming semi-cylindrical Bridge Support Pivot 33 to remain secure when swinging the Bridge Support Plate 7 as needed for assembly and disassembly. The Bridge Support Plate Tray 37 holds the Bridge Support Plate 7 in place laterally when in the fully assembled position.

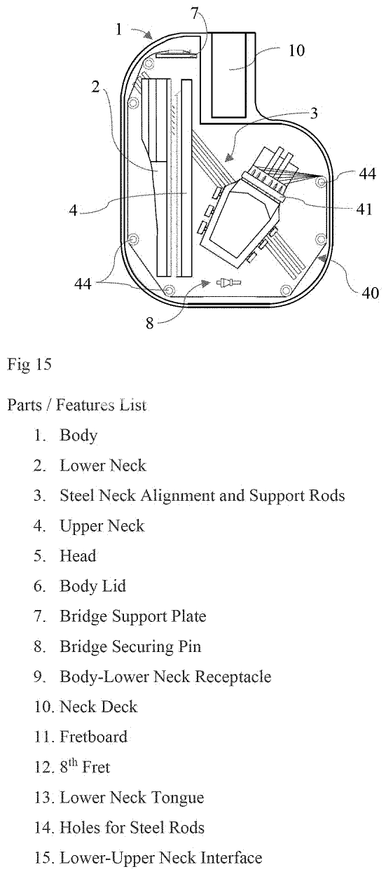

FIG. 14 is a full view of the underside of the Body Lid 6. The Bridge Plate Pivot Receptacle 36 is reinforced by the Bridge Support Plate Tray 37. The String Stowage Guideposts Pins 30 mate to the String Stowage Guideposts 44 (shown in FIG. 15). The outside wall of the Conforming Body Ridge 38 mates with the interior wall of the Body 1 (shown in FIG. 15), when the Body Lid 6 is put into place. Body Ridge Notches 32 are cut into the Conforming Body Ridge 38 which mate with lips on the Body 1 to help secure the Body Lid 6 in place.

FIG. 15 shows how the parts are stowed inside the Body 1 when the guitar is disassembled. The Body Lid 6 is put back in place once all the parts are inside. The guitar is then ready for placing in a small bag for transport.

The Body 1, Lower Neck 2, Upper Neck 4, Head 5, and Body Lid 6 are assembled, the Bridge Support Pivot 33 slides into the respective Bridge Support Pivot Receptacle 36. Assuming strings are already routed through the Tailpiece String Holes 35, the Bridge/Saddle Ensemble 34, the String Alignment Channels 25, the STATIC 43, and attached to the Tuning Pins 27, the Bridge Support Plate 7 is secured in place by pressing down on the distal end from the Bridge Support Pivot 33 until it sits fully in the Bridge Support Receptacle Tray 37. The Bridge Support Stabilizer 45 is placed over the Bridge Support Plate 7 whereupon the Bridge Securing Pin hole in the Bridge Support Stabilizer 45 is aligned with the Bridge Securing Pin Receptacle 31 in the Body 1. The Bridge Securing Pin 8 is inserted through the holes thus locking all parts into position. The instrument is now fully assembled and ready to play. The entire process takes less than one minute.

Disassembly occurs in reverse order of assembly. A built-in capo 41, which is a device for securing strings snuggly to an instrument's neck, is place over the Strings 40 between the Nut 18 and the Tuning Pins 27. Pressure is applied to the Bridge Support Plate 7 and the Bridge Support Stabilizer 45 while removing the Bridge Securing Pin 8 from the Bridge Securing Pin Receptacle 31. Once the Bridge Securing Pin 8 is fully removed, pressure on the Bridge Support Plate 7 is judiciously reduced such that it doesn't snap forward and potentially causing damage to the instrument. Once the Bridge Support Plate 7 is approximately 45 degrees in relation to the Body Lid 6, the Bridge Support Plate 7 is removed by removing the Bridge Support Pivot 33 out of the Bridge Support Pivot Receptacle 36. The Head 5 is then removed by pulling the Head Alignment Pins 24 out of the Upper Neck-Head Alignment Holes 22. The Bridge Support Plate 7 and the Head 5 are set aside in a manner such that the strings remain straight, string clamps may be used to further reduce the chance of string tangling. The Upper Neck 4 is removed from the Lower Neck 2 by pulling the pieces in opposing directions which exposes the three Steel Neck Alignment and Support Rods 3. The Steel Neck Alignment and Support Rods 3 are removed from both the Upper Neck 4 and Lower Neck 2. The Lower Neck 2 is then removed from the Body 1 by sliding it out of the Body-Lower Neck Receptacle 9. The Body Lid 6 is removed by pulling it straight up from the Body 1.

All of the pieces are now storable in the Body 1. Velcro, custom clasps, or other means of securing the pieces in the Body 1 may be used to store the pieces. FIG. 16 is one of many possible configurations with the Steel Neck Alignment and Support Rods 3 placed in first, followed by the Lower Neck 2, then the Upper Neck 4. The Bridge Support Plate 7 is then placed in the Body 1 and the strings are guided into place between the interior wall of the Body 1 and the String Stowage Guideposts 44. The String Stowage Guideposts may have notches cut in it to help ensure string separation and prevent tangling. The Head 5, with Strings 40 still attached and Capo 41 in place are laid in last. The perimeter of the Body 1 is such that the Strings 40 have no slack once the Head 5 is laid in place. The Head 5 is secured by any suitable means. The Body Lid 6, slides back into place onto the Body 1 until the Body Conforming Ridge 38 settles fully into place within the contour of the inner Body wall. The instrument is now ready to be placed in any small backpack or conventional laptop bag.

The foregoing describes one or more exemplary embodiments of an improved system for string instruments having a body and a neck. More particularly, the embodiments disclose a guitar including a body capable of encapsulating, storing, and transporting its detachable two-piece neck, detachable head, detachable bridge/saddle ensemble, and its strings within the instrument body. Moreover, the invention, when assembled, allows the enjoyment of play without compromising duration, timbre, and thus sound resonance.

That which is claimed is:

1. A stringed instrument, comprising:
a body;
a two-piece detachable neck;
a detachable head;
a detachable Bridge/Saddle; with
a single quick release pin, clip, or fastener that secures the entire instrument assembly, thereby reducing the time to assemble the instrument without tools; and whereby the time to dissemble or reassemble the guitar is less than a one minute.

2. The stringed instrument according to claim 1, wherein the body contains a receptacle defined by recessed long and rectangular grooves on both sides, a wall at the distal end of the receptacle opening, and a flat deck wherein the proximal end of the Lower Neck comprising a tongue on either side of like geometry, a flat end, and a flat lower surface, conforms and can be received.

3. The stringed instrument according to claim 2, wherein the present invention is distinctly unique in that the neck disassembles as two separate pieces, herein described as a lower neck and upper neck, and can be reassembled with such precision that it appears, feels, and is as effective, as a single piece neck.

4. The stringed instrument according to claim 3, wherein the lower and upper neck pieces contain three tubes pairings, wherein one half of each tube is embedded in the lower neck and the other half of each tube is embedded in the upper neck. The open ends of the tubes of the lower and upper neck mate when steel (or other comparable low flexibility alloy) rods are inserted into the lower neck's tubes and the upper neck is slid over the remaining exposed rods fully encasing the rods inside the tubes, thereby resulting in a fully stable neck with the same acoustic qualities of a solid neck.

5. The stringed instrument according to claim 3, wherein the upper neck extends beyond the nut which serves as a tab to insert into a receptacle on the instrument head to improve stability between the detachable head and the neck, and gives the same feel when playing as a single solid neck and head piece.

6. The stringed instrument according to claim 5, wherein the instrument head has a receptacle, of a matching geometry of the upper neck extension, such that it fully encases the upper neck extension when inserted and also blends to the upper neck at the nut so as to give the same feel when playing as a single piece neck and head.

7. The stringed instrument according to claim 6, wherein the head has tunnels for each string from its tuning pin to the channels that align the strings over the nut notches in proper order without tangling during assembly; and covers the tuning pins precluding the strings from sliding over the tuning pins and unraveling.

8. The stringed instrument according to claim 7, wherein the distal end of the strings' connection to the tuning pins is the string's connection to a bridge, which is mounted to a detachable bridge support that pivots (within a receptacle) downward until flush with the instrument's body, thus pulling the strings taut.

9. The stringed instrument according to claim 8 wherein the detachable bring support is secured in place by a locking avibank pin, or similar device, by passing it through a bridge support stabilizer or flap and through a hole in the guitar body.

10. The stringed instrument according to claim 8, wherein its design precipitates and depends only upon the strings' tension to apply an ample longitudinal force from the head through the neck and body when pulled taut by the secured bridge support such that neither tools nor additional hardware is required to hold the instrument's entirety in place.

11. The stringed instrument according to claim 1, wherein a series of guideposts perpendicular to the body's front (lid) and back, interspersed and running along the instrument body's inner wall perimeter leaving a small space between the wall and guideposts, wherein the instruments strings can be easily tucked between the guideposts and the inner perimeter of the guitar body thus reducing the time to wrap the strings around a tube or try to lay them in an orderly fashion without tangling or kinks.

12. The stringed instrument according to claim 11, wherein the instrument body's inner wall perimeter is the same length as the instrument's string length from the bridge to the head thus reducing the size of the guitar to its smallest overall size without overlaying the strings, thus preventing entanglement or kinking during transport or storage.

13. The stringed instrument according to claim 1, wherein the entirety of the instrument's pieces, when fully disassembled and detached from their respective mating pieces, can be encapsulated within the instrument's body.
